(19) United States
(12) Patent Application Publication
(10) Pub. No.: US 2005/0210508 A1
(43) Pub. Date: Sep. 22, 2005

(54) System and method for managing time-go-live information of media content

(76) Inventors: Vincent W. Lau, Sunnyvale, CA (US); Charles P. Binzel, Bristol, WI (US); John D. Brunner, South Barrington, IL (US); Mark D. Hansen, Buffalo Grove, IL (US); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/804,355

(22) Filed: Mar. 19, 2004

(51) Int. Cl. H04N 7/18; G06F 13/00; G06K 15/00; H04N 5/445; G06F 3/00; H04N 7/10; H04N 7/025; G06F 17/00

(52) U.S. Cl. 725/46; 725/81; 725/34; 715/747

(57) ABSTRACT

A wireless communication network, and a method thereof, for communicating with a remote device (104) via a wireless link comprising a transceiver (202) and a processor (204). The transceiver (202) obtains preference information relating to the remote device (104). The processor (204) adjusts time-to-live (TTL) information of at least one media content item based on the preference information. Also, the transceiver (202) provides a first media content item and a first TTL information associated with the first media content item to the remote device (104). In addition, the processor (204) identifies a second media content item associated with the first media content item, and determines a second TTL information based on the first media content item.

### FIELD OF THE INVENTION

The present invention relates generally to the field of systems and methods for providing information to wireless communication devices. More particularly, the present invention relates to systems and methods for providing applications and media artifacts, including text, video, audio and multimedia content, to wireless communication devices that utilize and interact with such content and/or related functions.

### BACKGROUND OF THE INVENTION

Advancements in computing networks have facilitated distribution of information to users of computing devices. Each computing device of a computing network may request access to information stored by other devices coupled to the network. A computing device coupled to a large network, such as the Internet, may have access to a similarly large amount of information.

One advancement in computing networks is the development of Push Technology. Unlike other systems which require each device to request information from information sources, Push Technology delivers information automatically to a device according to programmed preferences. Thus, Push Technology eliminates the need of a computing device to seek out one or more information sources to gather specific information of interest. Many companies utilize Push Technology to “push” software updates directly to various computing devices operated or otherwise owned by them.

Although Push Technology is often used for wired computing devices, it is less often used for providing information to wireless communication devices. Users of wireless communication devices frequently need access to a variety of information, but such information is not as readily available to wired connections due to the limited bandwidth of wireless connections. Wireless communication systems are challenged to maximize the quality of information provided to wireless communication devices while minimizing the traffic imposed on the wireless connections to the devices.

In view of the above, there is a need for a system and method for managing and displaying content on a display of a wireless communication device to maximize content quality. In particular, there is a need for a system and method that manages the active time period of media content in order to provide a user with as much useful, up-to-date information as possible.

### BRIEF DESCRIPTION OF THE DRAWINGS

FIG. 1 is a schematic diagram illustrating an exemplary embodiment in accordance with the present invention.

FIG. 2 is a block diagram illustrating exemplary internal components of various servers, controllers and devices that may utilize the present invention.

FIG. 3 is a schematic diagram illustrating an exemplary embodiment of a device in accordance with the present invention.

FIG. 4 is a flow diagram illustrating an exemplary operation for adjusting TTL information of appropriate items.

FIG. 5 is a flow diagram illustrating an exemplary operation for preparing preference information for the operation of FIG. 4.

FIG. 6 is a timing diagram illustrating an exemplary situation in which adjusted TTL information is used in accordance with the present invention.

FIG. 7 is a flow diagram illustrating an exemplary operation for modifying TTL information for appropriate items.

FIG. 8 is a table representing exemplary elements used to modify TTL information in accordance with the present invention.

FIG. 9 is a timing diagram illustrating an exemplary situation in which modified TTL information is used in accordance with the present invention.

### DETAILED DESCRIPTION OF THE PREFERRED EMBODIMENTS

The present invention provides the most relevant information to a wireless communication device. In particular, information is tagged with a Time to Live (TTL) value that may be used to remove older content. The present invention applies not only to channels of information but also sub-channels of information, such as individual items included with a channel of media content. The value may be determined at the time of generation and flagged to expire when the item is no longer relevant. Examples of items that may benefit from TTL values include, but are not limited to, weather, sports, traffic, stock market items, and other items with regular updates and limited life.

The system and method adjusts the TTL values of certain items based on user behavior, tracked by the receiving device, and/or other user preference provided by the user. If a user is interested in certain subject matter, as indicated by past user behavior, the TTL value may be adjusted accordingly by a server, such as a media gateway. Each item may be categorized in predetermined classes or types, and two or more items may be compared to determine whether they are related. Examples of past user behavior include, but are not limited to, number of articles with similar subject matter being read, amount of time spent on articles, and quantity of follow-on articles. Thus, a TTL value may be set to a longer value if an article falls within a category of interest, whereas the TTL value may be set to a shorter value and, thus, removed from the receiving device sooner if the article is not of interest.

The system and method also retroactively modifies the TTL value of an item already delivered. Some items, such as new breaking stories, may be provided with asynchronous timing, and the TTL value of an update may not be determined at the time of transmission. Thus, the TTL value of a given item is modified by sending an update signal to the receiving device that shortens or lengthens the TTL value. The system and method may also modify the TTL value of an item to overlap the TTL value of a related item previously provided to a device. A new time does not necessarily cause a previously-provided item to become irrelevant, so the TTL value is modified to reflect the current needs of a user.

One aspect of the present invention is a wireless communication network, and a method thereof, for communicating with a remote device via a wireless link comprising a transceiver and a processor. The transceiver obtains preference information relating to the remote device. The processor adjusts time-to-live (TTL) information of at least one media content item based on the preference information.

Another aspect of the present invention is a wireless communication network, and a method thereof, for communicating with a remote device via a wireless link comprising a transceiver and a processor. The transceiver provides a first media content item and a first time-to-live (TTL) information associated with the first media content item to the remote device. The processor identifies a second media content item associated with the first media content item, and determines a second TTL information based on the first media content item.

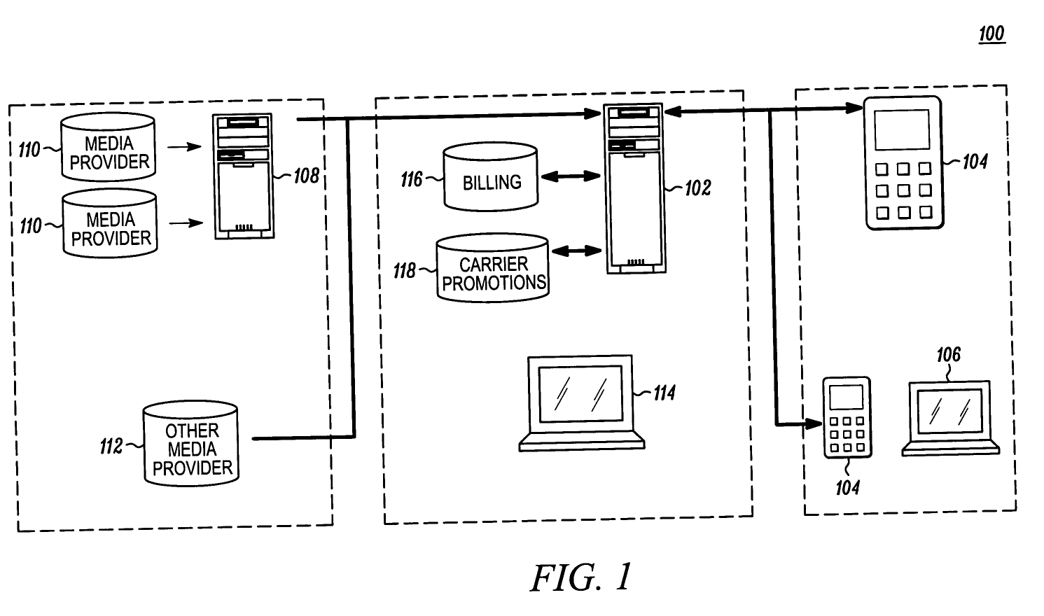

Referring to FIG. 1, there is provided a wireless communication system 100 in accordance with the present invention. The system 100 includes one or more media gateway 102 communicating via wireless link to a plurality of wireless communication devices 104. Any type of wireless link may be utilized for the present invention, but it is to be understood that a high speed wireless data connection is preferred. For example, each media gateway 102 may communicate with the plurality of wireless communication devices 104 via a cellular-based communication infrastructure that utilizes a cellular-based communication protocols such as AMPS, CDMA, TDMA, GSM, iDEN, GPRS, EDGE, UMTS, WCDMA and their variants. Each media gateway 102 may also communicate with the plurality of wireless communication devices 104 via a peer-to-peer or ad hoc system utilizing appropriate communication protocols such as Bluetooth and IEEE 802.11. A wireless communication device 106 may also communicate with the media gateway 102 indirectly via another wireless communication device 104 that is communicating with the media gateway directly. In such case, the indirect wireless communication device 106 may communicate with the direct wireless communication device 104 via a wireless link as described above or a direct link, such as a cable or connector. It is to be understood that any functionality of the wireless communication device 104 may also apply to the indirect wireless communication device 106 due to the communication between the devices via the above wireless link.

The media gateway 102 may receive feeds of media channels, buffer and cache the feeds, and feed them to wireless communication devices 104. The term “channel” refers to content that is received from a single content source and provided in a particular format, such as an XML language, and the term “feed” refers to fetching of a file from a particular channel. For one embodiment, the media gateway 102 compresses combined channels and provides them to the wireless communication devices 104 where they are decompressed, separated and stored in a content cache. The media gateway 102 may feed information to the wireless communication device 104 using push, pull and poll technology. For example, for one embodiment, the media gateway 102 generally pushes information to the wireless communication device 104, and the device pull technology from the media gateway upon request.

Although the media gateway 102 may operate on a common platform with other devices, the media gateway may also serve as a control point across multiple platforms. Regardless of the platform used, the media gateway 102 controls, bills and tracks information that is available to the wireless communication devices 104 and, thus, has access to media content from one or more sources. As shown in FIG. 1, the media gateway 102 may receive media content from a content aggregator 108 that collects media content from various media providers 110 and/or from media providers 112 directly. Preferably, all media content received by the media gateway are provided in a common format such as, for example, the XML language using the RDF Site Summary (RSS) specification. Some media providers 110 may not provide media content in a common format, so they may deliver the media content to the content aggregator 108. The content aggregator 108 may, in turn, convert the media content to a common format and forward the converted media content to the media gateway 102.

The media gateway 102 may also be directly controlled by a service provider, or be coupled to a cockpit controller 114 of a service provider, to manage the flow of billing information 116 and/or other media content 118, such as service provider promotions, for the wireless communication system 100.

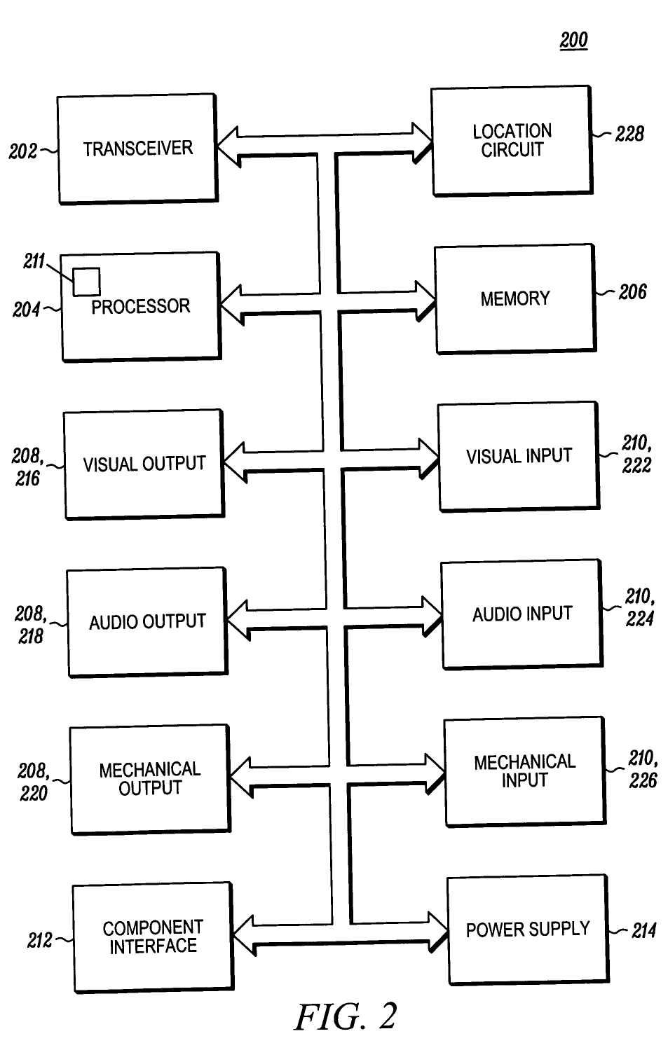

Referring to FIG. 2, there is provided a block diagram illustrating exemplary internal components of various servers, controllers and devices that may utilize the present invention. The exemplary embodiment includes one or more transceivers 202, a processor 204, a memory portion 206, one or more output devices 208, and one or more input devices 210. Each embodiment may include a user interface that comprises at least one input device 210 and may include one or more output devices 208. Each transceiver 202 may be a wired transceiver, such as an Ethernet connection, or a wireless connection such as an RF transceiver. The processor 204 may couple to, i.e., may include or be connected to, a timing circuit 211 that may determine the current time, i.e., current date and time of day, of the device. Unless otherwise stated, the term “time” as used herein may also include calendar date information as well as clock time information. The internal components 200 may further include a component interface 212 to provide a direct connection to auxiliary components or accessories for additional or enhanced functionality. The internal components 200 preferably include a power supply 214, such as a battery, for providing power to the other internal components while enabling the server, controller and/or device to be portable.

Referring to the media gateway 102, wireless communication devices 104 and content aggregator 108 shown in FIG. 1, each machine may have a different set of internal components. The media gateway 102 and the content aggregator 108 may include a transceiver 202, a processor 204, a memory 206 and a power supply 214 but may optionally include the other internal components 200 shown in FIG. 2. The memory 206 of the media gateway 102 and the content aggregator 108 should include high capacity storage in order to handle large volumes of media content. Each wireless communication device 104 must include a transceiver 202, a processor 204, a memory 206, one or more output devices 208, one or more input devices 210 and a power supply 214. Due to the mobile nature of the wireless communication device 104, the transceiver 202 should be wireless and the power supply should be portable, such as a battery. The component interface 212 is an optional component of the wireless communication device 104.

An exemplary function of the wireless communication device 104 as represented by the internal components 200, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for one or more output devices 208. Likewise, for transmission of wireless signals, the processor 204 formats outgoing information, which may or may not be activated by the input devices 210, and conveys the outgoing information to the transceiver 202 for modulation to communication signals. The transceiver 202 conveys the modulated signals to the media gateway 102 via a remote transceiver.

The input and output devices 208, 210 of the internal components 200 may include a variety of visual, audio and/or mechanical outputs. For example, the output device(s) 208 may include a visual output device 216 such as a liquid crystal display and light emitting diode indicator, an audio output device 218 such as a speaker, alarm and/or buzzer, and/or a mechanical output device 220 such as a vibrating mechanism. Likewise, by example, the input devices 210 may include a visual input device 222 such as an optical sensor (for example, a camera), an audio input device 224 such as a microphone, and a mechanical input device 226 such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device.

The internal components 200 of the media gateway 102, wireless communication devices 104 and content aggregator 108 may include a location circuit 228. Examples of the location circuit 228 include, but are not limited to, a Global Positioning System (GPS) receiver, a triangulation receiver, an accelerometer, a gyroscope, or any other information collecting device that may identify a current location of the device. The location circuit may also be an inherent function of the operation of some other component. For example, location information in the form of Cell ID may be available based on Cell ID. Further, determination of location may be a distributed function involving both the remote device and the network, such as in the case of Cell ID, EOTD or assisted GPS.

The memory portion 206 of the internal components 200 may be used by the processor 204 to store and retrieve data. The data that may be stored by the memory portion 206 include, but is not limited to, operating systems, applications, and data. Each operating system includes executable code that controls basic functions of the communication device, such as interaction among the components of the internal components 200, communication with external devices via the transceiver 202 and/or the component interface 212, and storage and retrieval of applications and data to and from the memory portion 206. Each application includes executable code utilizes an operating system to provide more specific functionality for the communication device, such as file system service and handling of protected and unprotected data stored in the memory portion 206. Data is non-executable code or information that may be referenced and/or manipulated by an operating system or application for performing functions of the communication device.

The processor 204 may perform various operations to store, manipulate and retrieve information in the memory portion 206. Each component of the internal components 200 is not limited to a single component but represents functions that may be performed by a single component or multiple cooperative components, such as a central processing unit operating in conjunction with a digital signal processor and one or more input/output processors. Likewise, two or more components of the internal components 200 may be combined or integrated so long as the functions of these components may be performed by the communication device.

The processor 204 may include an internal clock and perform an internal clock function to synchronize the internal clock with a corresponding clock of the server or servers that provide media content. In the alternative, the internal clock and the internal clock function may be performed by a separate component described above or an added component not shown. The internal clock and the internal clock function may be particularly important for items that include time-sensitive information.

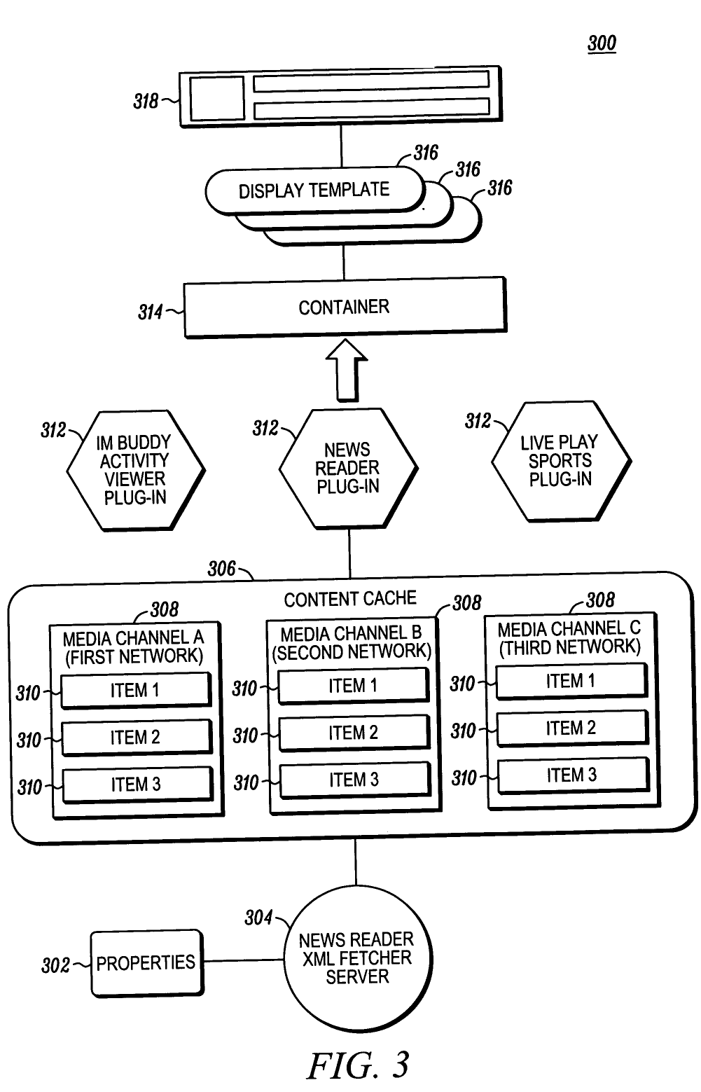

Referring to FIG. 3, there is provided a schematic diagram illustrating an exemplary embodiment of a device, such as wireless communication device 104. As described above, channels of content and properties 302, such as connection and channel settings, are received from one or more media gateways 102 by each wireless communication device 104. Channels are chosen from a list, synchronized on the media gateway 102, identifying channels that are available to the wireless communication device 104. The wireless communication device 104 includes a service 304, stored in the memory 206 and executed by the processor 204, that fetches content from the media gateway 102 and places them a content cache 306 of the memory. The content files and fetch details are specified by the channel settings and properties received from the media gateway 102. Each content file includes one or more items having information based on a common format, such as an XML schema based off RSS. For example, as shown in FIG. 3, the content cache 306 may store multiple channels 308 of content in which each channel may include multiple items 310 of content.

The exemplary embodiment of the device also includes one or more plug-ins 312 to provide functionality and one or more containers 314 operating as framework elements and having an area on the display. Examples of plug-in functionality include, but are not limited to, instant messaging buddy activity viewing, news reading and live play sport viewing. Each container 314 may be associated with one or more plug-ins 312. For example, as shown in FIG. 3, the news reader plug-in 312 is loaded into the container 314. For one embodiment, the plug-in 312 is designed to fetch XML (RSS) files and display the content referenced in the XML file for the container 314. The container 314 holds rules for interaction between loaded plug-ins based on where the container is displayed, e.g., idle status of the device.

The exemplary embodiment of the device further includes one or more display templates 316 and a display area 318, as referenced above, associated with a container 314. Each container 314 may provide a channel 308 of content, stored in the content cache 306, at the display area 318 of an output device 208. Individual items 310 of the channel 308 are displayed based on the container information and corresponding display template 316. The display template 316 defines the manner in which content is displayed at the display area 318. The display template 316 to use for a particular content is defined by channel settings for the current channel 308.

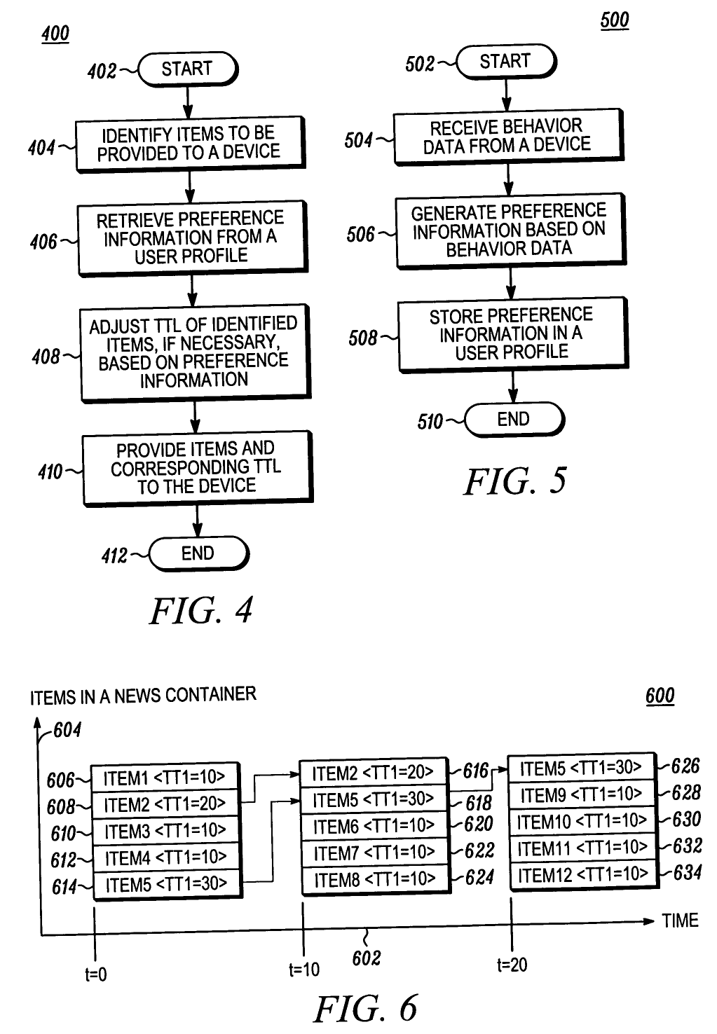

Referring to FIG. 4, there is provided a flow diagram illustrating an exemplary network operation 400 of the media gateway 102 for adjusting TTL information of appropriate items. The exemplary network operation 400 starts at step 402, and the media gateway 102 identifies items to be provided to one or more wireless communication devices 104 at step 404. For example, the media gateway 102 may collect media content from various sources 110, 112 and aggregate them into data packets for transport to the device or devices via a wireless link. The data packets may include channels of media content in which each channel includes a plurality of media content items. Next, the media gateway 102 retrieves preference information from a memory portion of the media gateway (or the wireless communication device 104 or any other device remotely-located) at step 406. For one embodiment, the media gateway 102 may receive the preference information from one or more wireless communication devices 104. The preference information may be received from the device 104 after the device generates the preference information based on behavior data collected by the remote device. The behavior data may be based on behavior usage of certain types of media content by the remote device. For another embodiment, a user of a device 104 may input the user preferences at a user interface of the device, and the device may provide the user preferences to the media gateway 102 via wireless link. In any case, the user preferences may be stored in a memory portion of the media gateway, as part of a user profile or by itself.

The media gateway 102 may then adjust the TTL value of the identified item, if necessary, based on the preference information at step 408. In particular, the media gateway 102 compares the identified items to the retrieved preference information to identify the items that need to be adjusted and adjusts the TTL value of each item that needs to be adjusted. Thereafter, the media gateway 102 provides the identified items and the corresponding TTL values, including the adjusted TTL values, to the device 104 at step 410, and the exemplary network operation 400 terminates at step 412.

Referring to FIG. 5, there is provided a flow diagram illustrating an exemplary device operation 500 for preparing preference information. In order for the media gateway 102 to perform the exemplary network operation 400 above, the wireless communication device 104 will need to provide preference information in advance, as performed by the exemplary device operation 500. The exemplary device operation 500 starts at step 502, and the device 104 receives behavior data from one or more of its input devices 210 at step 504. For example, the device 104 may monitor user interaction with its navigation device and display to identify media content of interest to the user. Examples of past user behavior include, but are not limited to, number of articles with similar subject matter being read, amount of time spent on articles, and quantity of follow-on articles. Next, the device 104 may generate preference information based on the collected behavior data at step 506. The device 104 may then store the preference information in its memory, in a memory portion of the media gateway 102 by wirelessly transmitting it to the media gateway, and/or in a memory portion of a remotely-located third device at step 508. Thereafter, the exemplary device operation 500 terminates at step 510.

Referring to FIG. 6, there is provided a timing diagram illustrating an exemplary situation in which adjusted TTL information is used. FIG. 6 is an adaptive TTL graph 600 representing time along its horizontal axis 602 and items in a container along its vertical axis 604. At time zero (t=0), an exemplary container of a wireless communication device 104 includes five items that may be shown at a display area of the device, namely a first item 606, a second item 608, a third item 610, a fourth item 612 and a fifth item 614. For this example, the first item 606, the third item 610 and the fourth item 612 have TTL values often (10), the second item 608 has a TTL value of twenty (20), and the firth item 614 has a TTL value of thirty (30). Also, the TTL values represent a time period, such as number of minutes, for caching the item before the item will be replaced by another item.

At time ten (t=10), the exemplary container of the device 104 still includes two of the original five items and now includes three new items. In particular, the exemplary container includes the second and fifth items 616, 618 and well as sixth, seventh and eighth items 620, 622, 624 at time ten (t=10). Since ten (10) units of time has past, the first, third and fourth items 606, 610, 612 have expired and are no longer in the exemplary container. At time ten (t=10), the second item 616 has ten (10) units of time left, and the fifth item 618 has twenty (20) units of time left. Also, the sixth, seventh and eighth items 620, 622, 624 have TTL values of ten (10).

At time twenty (t=20), the exemplary container of the device 104 still includes the fifth item 626, but the first, second, third and fourth items 606, 608, 610, 612 have expired and are longer in the exemplary container. Four new items, namely ninth, tenth, eleventh and twelfth items 628, 630, 632, 634, each having a TTL value of ten (10), have been added to the exemplary container.

As shown in FIG. 6, the TTL values vary from one item to another. The media gateway 102 determines an appropriate TTL value before providing them to the wireless communication device 104. A TTL value may be set to a longer value if an article falls within a category of interest, whereas the TTL value may be set to a shorter value if the article is not of interest. For example, the media gateway 102 may have set the TTL values of the first, third, fourth, sixth, seventh, eighth, ninth, tenth, eleventh and twelfth items 606, 610, 612, 620-634 to ten (10) if these items are note of interest to the user of the device. Likewise, the second item 608 may have a TTL value of twenty (20) if it includes subject matter having medium or average interest to the user, and the fifth item 614 may have a TTL value of thirty (30) if it includes subject matter having high interest to the user.

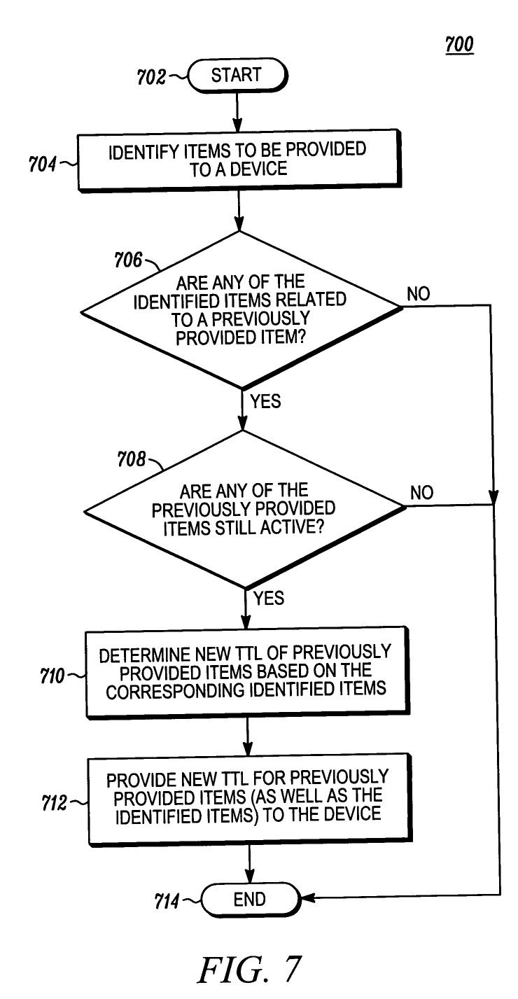

Referring to FIG. 7, there is provided a flow diagram illustrating a second exemplary network operation 700 for modifying TTL information for appropriate items. As described above, the media gateway 102 may also retroactively modify the TTL value of an item already delivered. The second exemplary network operation 700 starts at step 702, and the media gateway 102 identifies items to be provided to one or more wireless communication devices 104 at step 704 (similar to step 404 above). The media gateway 102 then determines whether any of the identified items are related to a previously provided item at step 706. For example, if an identified item is categorized as a type similar to a previously provided item, then the determination results in a positive answer. If an identified item is related to a previously provided item, then the media gateway 102 determines whether any of the previously provided items are still active at step 708. In particular, the media gateway 102 will only update TTL values of items that have not expired.

If an identified item is related to a previously provided active item, then the media gateway 102 determines a new TTL value of the previously provided active item based on the identified item at step 710. The TTL value of a given item is modified by sending an update signal to the receiving device that shortens or lengthens the TTL value, and the modified TTL value may overlap the TTL value of a related item. For example, breaking news stories may change the TTL values of older, related stories. If the contents of the older stories are covered completely by the new story, then, the TTL value of the older stories may be shortened. On the other hand, if some parts of the contents of the older stories are not covered by the new story and still may add value to the user, then the TTL value may be shortened slightly or perhaps even lengthened if important. Thereafter, the media gateway 102 provides the new TTL value for the previously provided item or items to the device 104 along with the identified items at step 712, and the second exemplary network operation 700 terminates at step 714.

As stated above, the media gateway 102 determines whether any of the identified items are related to a previously provided item at step 706 and whether any of the previously provided items are still active at step 708. If either of these determination result in a negative answer, then the second exemplary network operation 700 terminates at step 714.

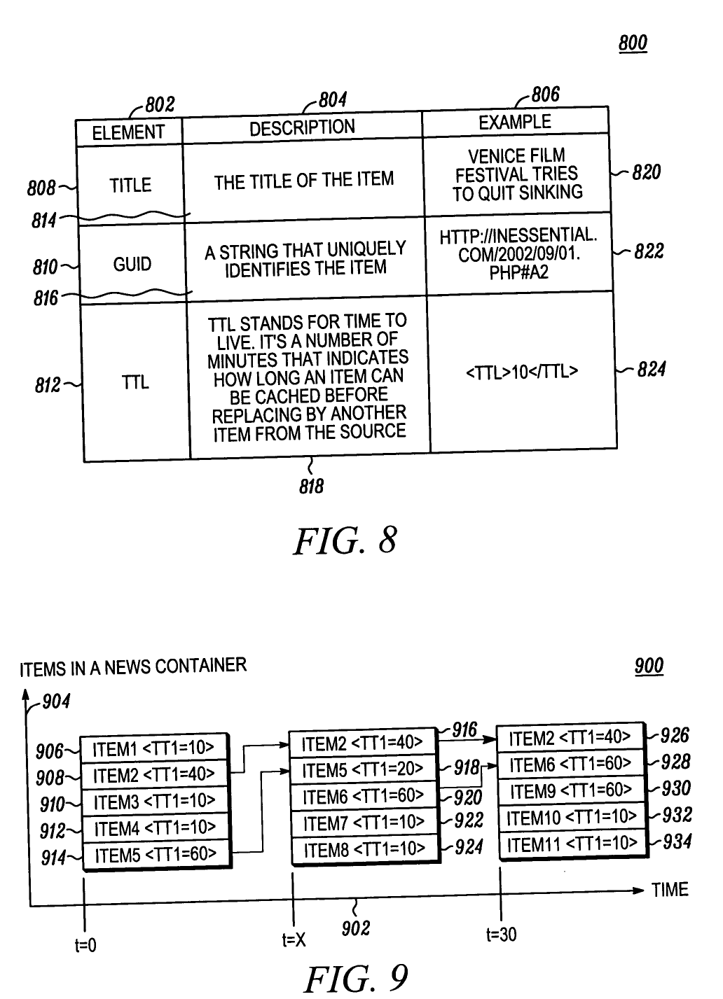

Referring to FIG. 8, there is provided a table 800 representing exemplary elements used to modify TTL information. This table 800 includes an Element column 802 identifying the exemplary elements, a Description column 804 providing a description of each element, and an Example column 806 providing examples of each element. As stated above, the TTL value of a given item is modified by sending an update signal to the receiving device that shortens or lengthens the TTL value. As represented by FIG. 8, the signal may include, but is not limited to, a title element 808, a guid element 810 and a time-to-live (“ttl”) element 812. The title element is the title of the item as shown by title description 814, and an example is provided by the title example 820. The guid element is a string that uniquely identifies the item as shown by the guid description 816, and an example is provided by the guid example 822. The“ttl”element is a number representing time, such as minutes, that indicates how long an item can be cached before being deleted or replaced by another item from its source as shown by the“ttl”description 818, and an example is provided by the“ttl”example 824. For one embodiment, the time (for example, minutes) in the TTL value may be relative to a published time of the item and used to calculate how long the item may be cached before being deleted or replaced by another item from the source. For example, for an item published at 8:00 AM and having a TTL value of 180 minutes, the item would have an expiration time of 11:00 AM even if it is downloaded at a later time, such as 8:15 AM.

The update signal must include the“ttl”element 802 and includes some type of identification to associate the“ttl”element to the corresponding item. As described above, such identification may include a title element 808 and/or a guid element 810. Other examples include, but are not limited to, a link element representing a uniform resource link of the item, a description element providing a synopsis of the item, an author element representing an address of the author of the item, a category element identifying a category type associated with the item, a comments element representing commentary associated with the item, an enclosure element describing one or more media objects attached to the item, a pubDate element indicating when the item was published, and a source item identifying the channel of origination for the item.

For one embodiment, the TTL value itself can be an absolute time. For another embodiment, a publish date of the item may be stored at the device so that it may compute the absolute time of expiration. In the latter instance, the table 800 may, for example, include a pubdate element that identifies the publication date and/or time of the item and takes the form of <pubdate>value</pubdate>. The format of the publication date may take any form to convey the appropriate date and/or time information, such as the number of units of time since a defined epoch (for example, midnight of Jan. 1, 1900) or perhaps YYYY-MM-DD HH:MM. For yet another embodiment, the publication date may be encoded as part of another element, such as the guid element.

Referring to FIG. 9, there is provided a timing diagram illustrating an exemplary situation in which modified TTL information is used. FIG. 9 is an modified TTL graph 900 representing time along its horizontal axis 902 and items in a container along its vertical axis 904. At time zero (t=0), an exemplary container of a wireless communication device 104 includes five items that may be shown at a display area of the device, namely a first item 906, a second item 908, a third item 910, a fourth item 912 and a fifth item 914. For this example, the first item 906, the third item 910 and the fourth item 912 have TTL values of ten (10), the second item 908 has a TTL value of forty (40), and the fifth item 914 has a TTL value of sixty (60). Also, the TTL values represent a time period, such as number of minutes, for caching the item before the item will be deleted or replaced by another item.

At time x (t=x), the exemplary container of the device 104 still includes two of the original five items and now includes three new items. In particular, the exemplary container includes the second and fifth items 916, 918 and well as sixth, seventh and eighth items 920, 922, 924 at time x (t=x).

When the media gateway 102 provides a new TTL value to the device 104, the new TTL value may be measured from the starting time of the original item or from the update time. For example, for the fifth item 918 of time x (t=x), the TTL value may represent twenty units of time from time zero (t=0) or from time x (t=x). If, for this example, the TTL value is counted from time zero (t=0), then x is presumed to be less than 20 units because the media gateway 102 would not update an item that is expired. If, on the other hand, the TTL value is counted from the time x (t=x), then x is presumed to be less than 10 units because the fifth item 918 expires before time 30 (t=30).

If at least ten (10) units of time has past, then the first, third and fourth items 906, 910, 912 have expired and are longer in the exemplary container. At time x (t=x), the sixth item 920 has a TTL value of sixty (60), and the seventh and eighth items 922, 924 have TTL values of ten (10). As stated above, the new TTL value may be measured from the starting time of the original item or from the update time. Thus, the second item 916 may have forty (40) minus x units of time left of forty (40) units of time left, depending upon the embodiment applied.

For the modified TTL graph 900, it is important to note that the fifth item 918 has a TTL value of twenty (20) at time x (t=x), whereas the fifth item 914 had a TTL value of sixty (60) at time zero (t=0). Thus, for this example, the media gateway 102 identified the sixth item 920 and further determined that the sixth item includes subject matter related to the subject matter of the fifth item 918. Accordingly, the media gateway 102 provided an update signal to reduce the TTL value of the fifth item 918 to twenty (20) based on the introduction of the sixth item 920.

At time 30 (t=30), the exemplary container of the device 104 still includes the second item 926 and the sixth item 928, but the fifth, seventh and eighth items 918, 922, 924 have expired and are longer in the exemplary container. Three new items, namely ninth, tenth and eleventh items 930, 932, 934, have been added to the exemplary container.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method for a wireless communication network comprising:
obtaining preference information relating to a remote device; and
adjusting time-to-live (TTL) of at least one media content item based on the preference information.

2. The method of claim 1, further comprising receiving the preference information from the remote device.

3. The method of claim 2, wherein the preference information is received from the remote device after the remote device generates the preference information based on behavior data collected by the remote device.

4. The method of claim 3, wherein the behavior data is based on behavior usage of certain types of media content by the remote device.

5. The method of claim 2, wherein receiving the preference information from the remote device includes receiving user preferences specified by a user of the remote device.

6. The method of claim 1, further comprising identifying the media content items to be provided to the remote device before obtaining preference information relating to a remote device.

7. The method of claim 1, further comprising providing the media content items and corresponding TTL, including adjusted TTL, to the remote device.

8. The method of claim 1, further comprising storing the preference information in a user profile.

9. A wireless communication network for communicating with a remote device via a wireless communication link comprising:
a transceiver configured to obtain preference information relating to the remote device; and
a processor configured to adjust time-to-live (TTL) of at least one media content item based on the preference information.

10. The wireless communication network of claim 9, wherein the transceiver receives the preference information from the remote device.

11. The wireless communication network of claim 9, wherein the preference information is generated based on behavior data collected by the remote device.

12. The wireless communication network of claim 11, wherein the behavior data is based on behavior usage of certain types of media content by the remote device.

13. The wireless communication network of claim 10, wherein the preference information is based on user preferences specified by a user of the remote device.

14. The wireless communication network of claim 9, wherein the processor identifies the media content items to be provided to the remote device by the transceiver before obtaining the preference information relating to the remote device.

15. The wireless communication network of claim 9, wherein the transceiver provides the media content items and corresponding TTL, including adjusted TTL, to the remote device.

16. The wireless communication network of claim 9, wherein the processor stores the preference information in a user profile.

17. A method for a wireless communication network comprising:
providing a first media content item and a first time-to-live (TTL) associated with the first media content item to a remote device;
identifying a second media content item associated with the first media content item; and
determining a second TTL based on the first media content item.

18. The method of claim 17, further comprising providing the second media content item and the second TTL to the remote device.

19. The method of claim 17, wherein identifying a second media content item associated with the first media content item includes determining the first and second media content items are similar types of media content.

20. The method of claim 17, further comprising determining whether the first media content item is still active.

21. The method of claim 17, further comprising identifying media content items to be provided to the remote device before providing the first media content item and the first TTL to the remote device.

22. A wireless communication network for communicating with a remote device via a wireless communication link comprising:
a transceiver configured to provide a first media content item and a first time-to-live (TTL) associated with the first media content item to the remote device; and
a processor configured to identify a second media content item associated with the first media content item, and to determine a second TTL based on the first media content item.

23. The wireless communication network of claim 22, wherein the transceiver provides the second media content item and the second TTL to the remote device.

24. The wireless communication network of claim 22, wherein the processor determines that the first and second media content items are similar types of media content.

25. The wireless communication network of claim 22, wherein the wireless communication network determines whether the first media content item is still active.

26. The wireless communication network of claim 22, wherein the processor determines media content items to be provided to the remote device before providing the first media content item and the first TTL to the remote device.

27. A method for a wireless communication device comprising:
receiving a media content item and a first time-to-live (TTL) associated with the media content item from a remote device; and
receiving an identifier and a second TTL associated with the media content item from the remote device;
identifying the media content item based on the identifier; and
replacing the first TTL with the the second TTL.

28. The method of claim 27, wherein receiving a second TTL and an identifier associated with the media content item from the remote device includes receiving the second TTL and at least one of the media content item, a title, a guide, a link, an author, a category, a comment, an enclosure, a publication date, and a source.

29. The method of claim 27, wherein receiving a second TTL and an identifier associated with the media content item from the remote device includes receiving the second TTL and the identifier a periodic time period after receiving the media content item and the first TTL.

30. The method of claim 27, further comprising determining whether the media content item is still active.

31. The method of claim 30, wherein replacing the first TTL with the the second TTL occurs in response to determining that the media content item is still active.
